(19) United States
(12) Patent Application Publication
(10) Pub. No.: US 2001/0050483 A1
(43) Pub. Date: Dec. 13, 2001

(54) Motor vehicle door lock with a compact structure

(76) Inventors: Dirk Hanisch, Koeln (DE); Horst Arlt, Wuelfrath (DE); Bernd Weyerstall, Wuppertal (DE)

Correspondence Address: NIXON PEABODY, LLP, 8180 GREENSBORO DRIVE, SUITE 800, MCLEAN, VA, 22102, US

(21) Appl. No.: 09/783,396

(22) Filed: Feb. 15, 2001

(30) Foreign Application Priority Data
Feb. 15, 2000 (DE) 100 06 765.4

(51) Int. Cl. E05C 3/06

(52) U.S. Cl. 292/216

(57) ABSTRACT

A motor vehicle door lock including a housing having an inlet slot and an intermediate wall with two sides, a stiff cover plate, at least two bearing axes having a lock element supported thereon, each bearing axes being supported by one side of the intermediate wall, and a lock mechanism with plurality of levers which are at least one of pivotally and movably supported on the at least two bearing axes, the plurality of levers being mounted on another side of the intermediate wall of the housing, where at least one of the lock elements are anchored to at least one of the cover plate and a bearing journal. A bearing journal molded to the housing may include an asymmetrical, T-shaped head. The bearing axis of the lock latch may include a bearing mount adapted to receive a bearing journal of a swiveling operating lever. A clevis type eyelet and a guide hook and/or flat spiral spring may also be provided. An overload safeguard including a journal received in an elongated hole with at least one spring element located therein between may also be provided.

### BACKGROUND OF THE INVENTION

1. Field of the Invention

The present invention relates to the field of motor vehicle door locks with a compact structure.

2. Description of Related Art

A motor vehicle door lock with a compact structure having a plastic housing with a stiff, metal cover plate is known from the prior art German patent DE 38 32 952 C2. In the motor vehicle door lock disclosed in this reference, a central interlock drive is integrated into the housing. For this reason, a corresponding section for holding the central interlock drive is integrated into the housing and covered with a plastic cover. From the plastic cover, a driven shaft projects out and is coupled to an inside safety lever of the lock mechanism. The electric central interlock drive is located in the housing protected against moisture. Overall, the housing is compact and achieves additional protection against moisture by the fact that the lock elements on one side of the housing which lies between the intermediate wall and the cover plate in the wet area are connected by only a few penetrations to the lock mechanism on the other side of the intermediate wall of the housing in the dry area.

Numerous embodiments of motor vehicle door locks of the type under consideration are known. For example, the published German application DE 195 39 753 A1 discloses an integrated central interlock drive with a gear spindle and a running nut in a multi-part housing built in the manner of a shell. Numerous details of drives for motor vehicle door locks, such as centrifugal clutches are known as exemplified by the published German application DE 39 13 995 A1.

A bent metal cover plate in which the bend extends into the area of the lock mechanism as shown in the German Patent DE 42 22 018 C1 is especially advantageous due to the inherent stiffness of the motor vehicle door lock which is of great importance, especially in an accident since it absorbs the forces which act to fling open the door. These bent cover plates are, of course, also known prior art in conjunction with plastic housings or plastic catch bearings.

### SUMMARY OF THE INVENTION

The primary object of the invention is to further improve the above explained known motor vehicle door lock without negatively impacting the compact structure.

The aforementioned object and other objects and advantages are achieved in a motor vehicle door lock with a compact structure, comprising a housing having an inlet slot adapted to receive at least one of a lock hook and a catch bearing, and also having an intermediate wall with two sides, a stiff cover plate that covers at least a portion of the housing, at least two bearing axes having a lock element supported thereon, each bearing axes being supported by one side of the intermediate wall, and a lock mechanism with plurality of levers which are at least one of pivotally and movably supported on the at least two bearing axes, the plurality of levers being mounted on another side of the intermediate wall of the housing, where at least one of the lock elements are anchored to at least one of the cover plate and a bearing journal. In accordance with various embodiments, at least one of the lock elements is anchored to a bearing journal molded to the housing or to a bearing journal molded on the cover plate. In such an embodiment, the bearing journal molded to the housing may include an asymmetrical, T-shaped head at one end, while a lever supported thereon includes an appropriate shaped opening that allows the lever to be slipped on and turned around the bearing journal by a certain angle of approximately 90° to thereby secure the lever against being pulled off of the bearing journal. Preferably, the lock elements include a lock latch and a detent pawl.

In accordance with another embodiment of the present invention, the housing includes an integrated section for holding a central interlock drive, the integrated section being adapted to be covered with a plastic cover. The central interlock drive may include an electric drive motor, a threaded spindle coupled to a centrifugal clutch and parallel to the electric drive motor, a running nut, and a swiveling operating lever adapted to be moved by the running nut, the operating lever extending from the integrated section for the central interlock drive into the lock mechanism.

In accordance with still another embodiment of the present invention, the bearing axis of the lock latch may include a bearing mount on an end facing the lock mechanism, the bearing mount being adapted to receive a bearing journal of the swiveling operating lever. In such an embodiment, the plastic cover of the central interlock drive may include another bearing mount adapted to receive another bearing journal of the operating lever.

In other embodiments of the present invention, at least one of the plurality of levers may be provided with a clevis type eyelet and a guide hook which is at angle thereto for connecting an actuating element to the lever. Alternatively or in addition to, the plurality of levers may be coupled to a flat spiral spring and is spring-pretensioned, the flat spiral spring being locked by a beveled clip on the cover plate, the clip having an undercut on an edge-side.

In accordance with yet another embodiment of the present invention, at least one of the plurality of levers of the lock mechanism may be coupled to another lever via an overload safeguard. In this regard, at least one of the plurality of levers may be an inside safety lever and the another lever may be a central safety lever. The overload safeguard may be integrally provided in one of the coupled levers by the lever's elasticity. Preferably, the overload safeguard includes a journal received in an elongated hole with at least one spring element located between the journal and the elongated hole. The journal is preferably received in the elongated hole between two spring elements which may be made of an elastomer element and have different spring hardnesses.

In still another embodiment of the present invention, the cover plate includes a bend at about 90° that projects into the lock mechanism and further includes at least one of a lever, an open by wire (OBW) module, and a child safety module that is supported on the bend.

These and other objects, features and advantages of the present invention will become more apparent from the following detailed description of the preferred embodiments of the invention when viewed in conjunction with the accompanying drawings.

### BRIEF DESCRIPTION OF THE DRAWINGS

FIG. 1 shows in a perspective view of one embodiment of a motor vehicle door lock in accordance with the present invention;

FIG. 2 shows in a different perspective view of the motor vehicle door lock of FIG. 1 but with the metal cover plate being removed;

FIG. 3 shows in a rear perspective view the motor vehicle door lock of FIG. 1;

FIG. 4 shows in a rear perspective view of a motor vehicle door lock of FIG. 3, but with the cover of the central interlock drive removed;

FIG. 5 shows a schematic illustration of a section of the motor vehicle door lock of FIG. 3 in the area of the central interlock drive together with the operating lever;

FIG. 6 shows a further modified embodiment of a motor vehicle door lock in accordance with the present invention, only an extract of the lock mechanism being shown;

FIG. 7 shows a side view of yet another embodiment of a motor vehicle door lock in accordance with the present the invention which is equipped with an auxiliary opening drive (OBW drive).

### DETAILED DESCRIPTION OF THE PREFERRED EMBODIMENT

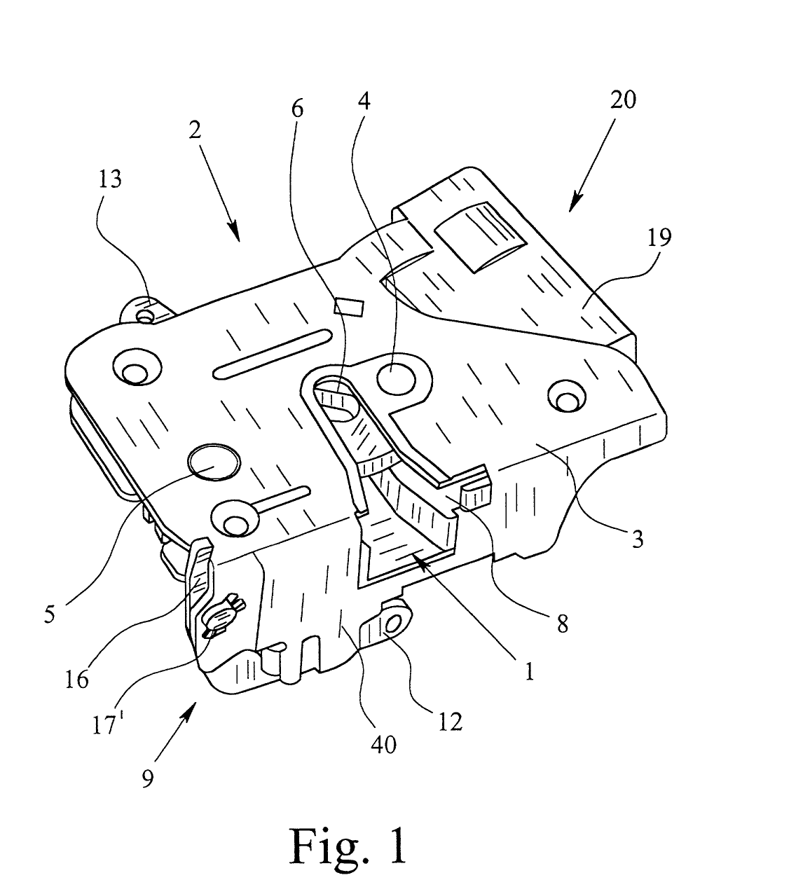

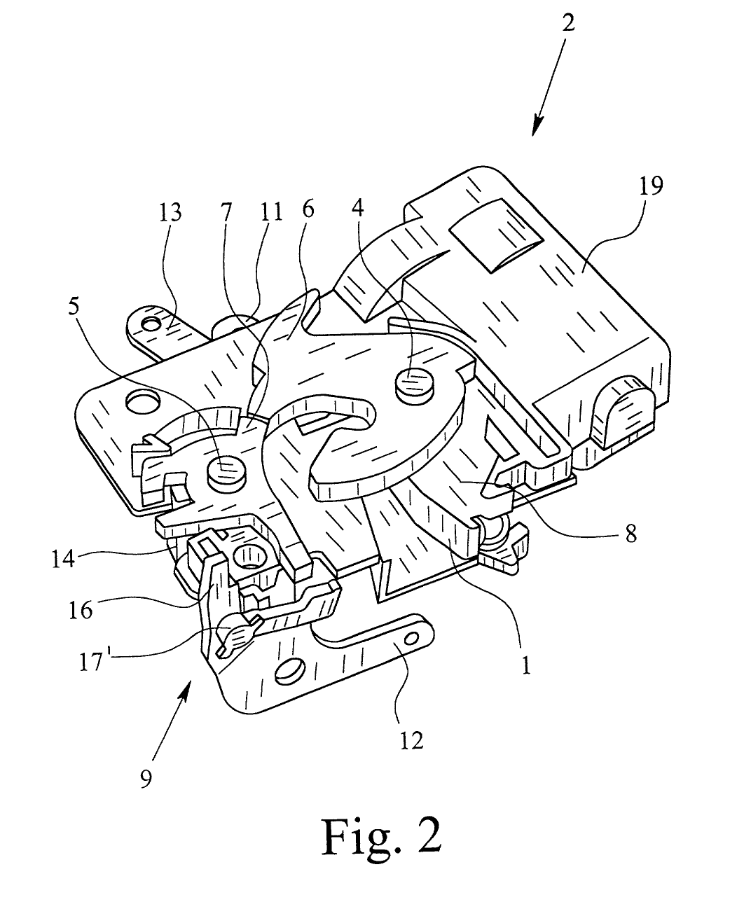

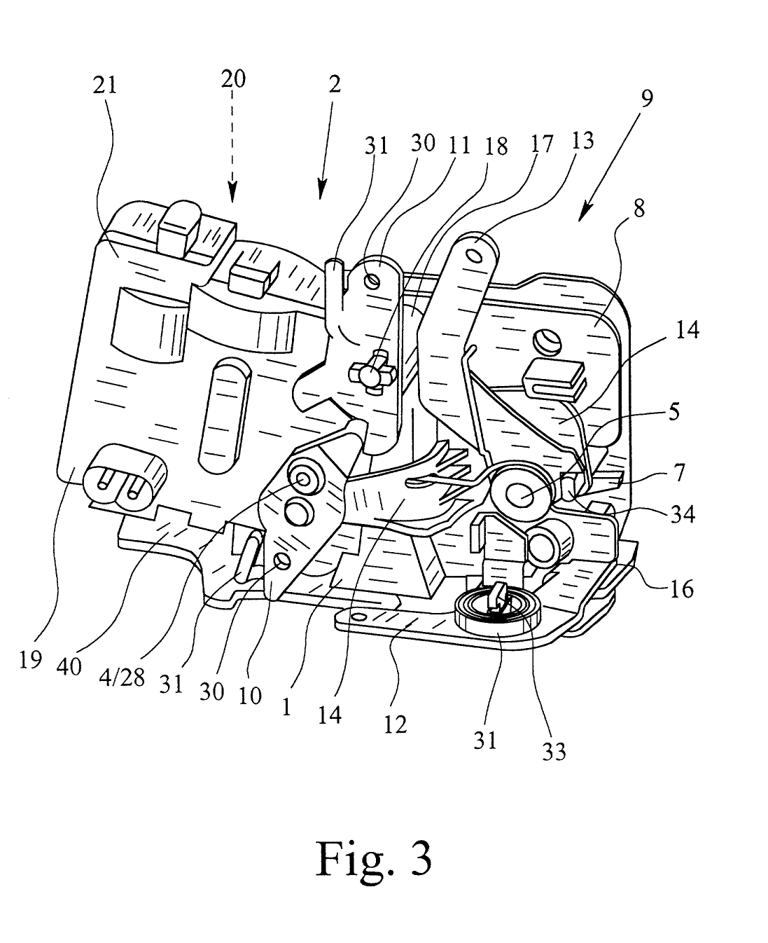

FIG. 1 shows in a perspective view a motor vehicle door lock in accordance with one embodiment of the present invention having a compact structure. However, for better understanding, FIGS. 2 and 3 should be referenced together with FIG. 1. As noted previously, the present invention is directed to motor vehicle door locks of the general type also previously discussed. In this regard, it should be initially noted that the motor vehicle door lock discussed herein below is not only applicable as a door lock for the side door of a motor vehicle, but also as a door lock for a rear door or a rear hatch.

For the compact structure of the motor vehicle door lock, one important purpose is to optimally use the existing parts and components. The various teachings of the present invention is used for this purpose as will be evident below.

The motor vehicle door lock in accordance with one embodiment of the present invention as shown in FIGS. 1, 2 and 3 has a plastic housing 2 which on one side, has an inlet slot 1 for the lock hook (not shown). The housing 2 is also referred to as the catch bearing because as a plastic component, it accommodates the inlet slot 1 for the lock hook and thus, to a certain extent, is used as the bearing for catching the look hook when the motor vehicle door is slammed.

FIG. 1 also shows a stiff, metal cover plate 3 for the motor vehicle door lock. Of course, fundamentally, it is also conceivable that with modem materials, the necessary tearing strengths can also be achieved with reinforced plastics. Between the cover plate 3 and the housing 2, there are lock elements supported on bearing axes 4 and 5, in particular, a lock latch 6 and a detent pawl 7 as clearly shown in FIG. 2. The lock latch 6 is held in the closed position in the conventional manner, preferably in a preliminary catch and in a main catch. These two element are more clearly apparent in FIG. 2. FIG. 1 shows only the lock latch 6 in the inlet slot 1. FIG. 2 shows that the lock elements 6,7 lie on one side of an intermediate wall 8 of the housing 2. This intermediate wall is used in the conventional manner to separate the space of the lock elements 6, 7 which is exposed to humidity, from the space of the lock mechanism 9. Here, the separation means which separates the lock elements 6,7 from the space of the lock mechanism 9 does not always form a full and complete separation. However, generally, such separation is provided to adequately prevent entry of water or humidity into the lock mechanism 9.

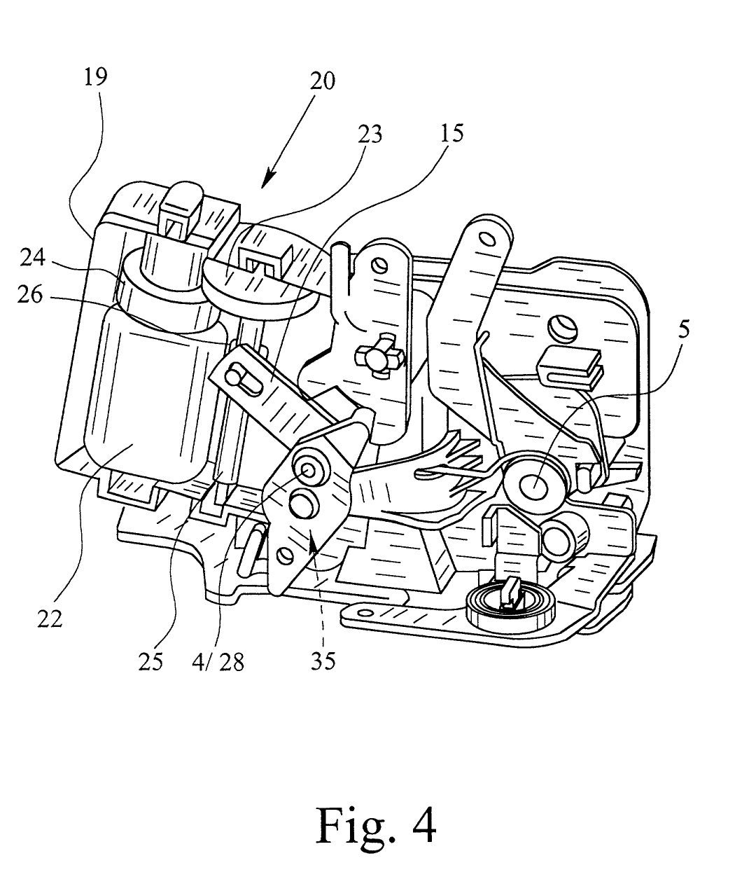

The lock mechanism 9 on the other side of the intermediate wall 8 of the housing 2 comprises a plurality of levers which are pivotally and/or movably supported. In this regard, the illustrated embodiment as shown in FIG. 3 and 4 includes an inside safety lever 10, an outside safety lever 11, an inside actuating lever 12, an outside actuating level 13, a central safety lever 14, an operating lever 15, and in this embodiment, also a mechanical child safety lever 16. To the extent necessary, these levers are discussed later. In the various embodiments of the motor vehicle door lock in accordance with the present invention, these individual levers can also be omitted. For example, rear side door locks of motor vehicles of course generally do not have the outside safety lever 11, and the front side door locks generally do not have the child safety lever 16. In addition, purely mechanically operating side door locks, of course, do not have operating lever 15.

It is of interest at this point that the various levers enumerated 10-16 of the lock mechanism 9 are supported on the bearing axes 4, 5 of the lock elements 6, 7 which are anchored in the cover plate 3 and/or on the bearing journal 17 that is molded to the housing 2 from the plastic material of the housing 2. This can be recognized especially clearly by comparing FIG. 3 with FIG. 2 in regards to the bearing axis 5 for the detent pawl 7. The bearing axis 5 is anchored in the cover plate 3 and supports the detent pawl 7 between the cover plate 3 and the intermediate wall 8. The bearing axis 5 is also routed through the intermediate wall 8 of the housing 2 and projects into the area of the lock mechanism 9 as shown in FIG. 3, where it supports the outside actuating lever 13 and is encompassed by the central safety lever 14 with a recess. For the outside safety lever 11, a plastic bearing journal 17 is molded to the housing 2 as can be seen. This bearing technology does not necessarily apply to all levers enumerated 10-16 of the lock mechanism 9. However, for some of the levers 10-16 of the lock mechanism 9, it can be useful and economical and can save space for the structure of the motor vehicle door lock.

FIG. 3 furthermore shows that it is an especially good idea that in this embodiment, at least one of the bearing journals 17 molded to the housing 2 has an asymmetrical, especially T-shaped head 18 on the end, to which an appropriate opening corresponds in the assigned lever 11 which is to be supported there. In this way, the lever 11 can be slipped on, and by turning it around the bearing journal 17 by a certain angle of roughly 90° in the embodiment shown, it is secured against being pulled off of the bearing journal 17. In this way, a very simple mounting technology is accomplished which also offers major advantages in terms of production engineering.

The exactly reversed technology can be implemented when in the material of the housing 2 or in the cover plate 3 is provided with a similar T-shaped recess, into which a T-head that is molded on the corresponding lever is introduced. This can be recognized as an attachment possibility in FIG. 1 for the child safety lever 16 on the cover plate 3 by means of the bearing journal 17′.

FIGS. 3 and 4 together illustrate that in the preferred embodiment of the motor vehicle door lock in accordance with the present invention shown, a section 19 for holding a central interlock drive 20 is integrated into the housing 2 and is covered with a plastic cover 21, as is known from the prior art. All types of central interlock drives 20 are possible here such as a worm wheel drive that are known in the prior art and need not be detailed here.

In this embodiment as shown in FIG. 4, it is specifically provided that the central interlock drive 20 here includes an electric drive motor 22, and a threaded spindle 25 which is parallel thereto and which is coupled via a gear 23 to a centrifugal clutch 24, and a running nut 26. The central interlock drive 20 is coupled to the lock mechanism 9 by means of a swiveling operating lever 15 which can be moved by the running nut 26 and which in this embodiment, extends laterally from the assigned section 19 of the housing 2 between the edge of the housing 2 and the plastic cover 21. The central interlock drive 20 of the type shown is especially advantageous in the present arrangement, but has also been known in the prior art. One such central interlock drive 20 with a threaded spindle and running nut can also be easily provided with an additional antitheft measure (such as a deadlock) known in the prior art based on structural constraints. Otherwise reference should be made to the extensive prior art.

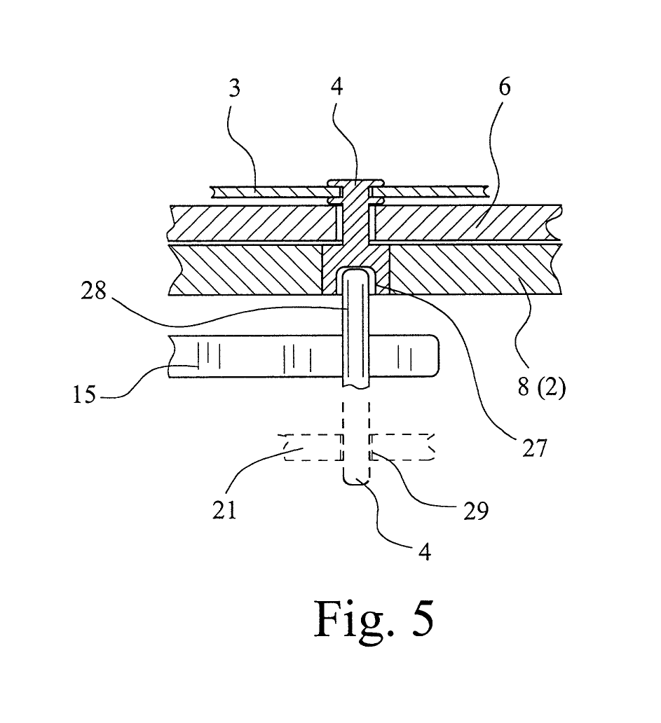

It is of interest for the embodiment of a motor vehicle door lock shown and the desired advantage of an especially compact structure that in this embodiment as more clearly shown schematically in FIG. 5, the bearing axis 4 of one of the lock elements, namely the lock latch 6, has a bearing mount 27 for a bearing journal 28 or the like of a lever such as the operating lever 15 of the central interlock drive 20 in this embodiment. In contrast to the motor vehicle door locks of the prior art, the bearing axle 4 for the lock latch 6 is routed not simply through the intermediate wall 8 of the housing 2 for use in the area of the lock mechanism 9 as the bearing axis, but it is to a certain extent “negatively” deformed. This can be easily done because the head must be struck accordingly anyway for attachment. This takes place here especially such that the bearing mount 27 for the bearing journal 28 of the operating lever 15 is formed. Also as shown in FIG. 5, a second bearing mount 29 for the bearing journal 28 may be formed by the plastic cover 21 of the housing 2, especially in this embodiment of the plastic cover 21 of the section 19 of the housing 2 that is assigned to the central interlock drive 20. Thus, one simple, feasible bearing possibility for the operating lever 15 is devised without major cost.

The structure in accordance with the present invention is made especially simple and compact in a further respect described below. More specifically, as shown in FIG. 3, at least one of the levers 10-14 which can be connected to the actuating elements that are spaced apart from the motor vehicle door lock may be provided with a clevis type eyelet 30, and a guide hook 31 which is at angle thereto for the connecting element (not shown). In the prior art, the levers have only simple clevis type eyelets. Typically, one end of a rod is used as a connecting element, the end which may be bent, must be secured in the simple clevis type eyelet by a snap ring or the like to prevent the rod from slipping out. This is relatively costly, but especially complex in terms of installation. The embodiment shown assigns the fixing (i.e. securing) function of the snap ring or the like to the guide hook 31 into which the connecting element is easily swiveled after suspension in the clevis type eyelet 30. Then, the connecting element can no longer slip out of the clevis type eyelet 30.

It is noted that in FIG. 3, various levers are provided with such features including the inside safety lever 10, an outside safety lever 11, an inside actuating lever 12, an outside actuating level 13, but these features are all enumerated using the same numerals for clarity in discussion. This embodiment shows different approaches because there are different actuation directions and actuation forces. In any case, wherever it can be accomplished in terms of application, the clevis type eyelet 30 and the guide hook 31 offer the aforementioned advantages.

FIG. 3 furthermore shows another structural feature particular to the motor vehicle door lock of the present invention in which one of the levers such as the inside actuation lever 12, is coupled to a flat spiral spring. The lever, in this example, the actuation lever 12 is spring-pretensioned such that the flat spiral spring 32 is supported locked on a clip 33 which is beveled on the cover plate 3 which is undercut on the edge-side to protect the flat spiral spring 32 from being pulled off the clip 33. Until now, the prior art door locks have required that the T-shaped head of the clip 33 be turned around the vertical axis of the clip 33 in a production step as soon as the flat spiral spring 32 has been slipped on or otherwise installed. It has been recognized by the present inventors that undercutting of the clip 33 is inherently sufficient because the flat spiral spring 32 is pressed by spring-pretensioning anyway to the edges of the clip 33. If the clip is undercut there, the flat spiral spring 32 can no longer slip upward in operation. This concept eliminates one step in production and thus, saves time and money.

FIG. 3 in conjunction with FIG. 4 shows that the bearing axis 4 for the lock latch 6 is not only the bearing axis for the operating lever 15 for the central interlock drive 2, but also supports the inside safety lever 10 at the same time. The bearing axis 4 is connected torsionally to the operating lever 15 as is known from the prior art. Laterally offset to the bearing axis 4 or the bearing journal 28 of the operating lever 15 in FIGS. 3 and 4, the central safety lever 14 is pivotally coupled to the inside safety lever 10. FIGS. 3 and 4 jointly show the unlocked, unactuated position of the lock mechanism 9. If, for example, by actuating the outside safety lever 11 or by direct actuation, the inside safety lever 10 from the position shown in FIG. 3 is turned counterclockwise around the bearing journal 28, the central safety lever 14 is pushed to the right in FIGS. 3 and 4. The coupling lug 34 disengages from the outside actuation lever 13 so that it can be moved in freely and out of operating engagement.

For interaction of the outside actuating lever 13 with the central safety lever 14, there are now special situations which must be considered in practice and should be included in the construction of the motor vehicle door lock. The first situation leads to operation of a “lockout safety”. This results in that with the motor vehicle door opened, the motor vehicle door lock cannot be moved into the “secured” operating position by means of the key or the inside safety button. This is designed to prevent the door from being slammed in the locked state when the key is still in the ignition lock or elsewhere in the motor vehicle. This “lockout safety” is implemented at least on the driver's door.

So that the motor vehicle door lock is not damaged, it is conventional known in motor vehicle door locks to install an overload safeguard at the proper site. It is therefore known to couple at least one lever of the lock mechanism 9 such as the inside safety lever 10, to another lever such as the central safety lever 14 by means of an overload safeguard 35.

Another function likewise requires an overload safeguard, but in the other direction of action. In this “enhanced circuit” function, the motor vehicle door lock can also be unlocked from the inside even if at the same time, actuation takes place from the outside and therefore, the outside actuation lever 13 has been pulled. Nevertheless, unlocking is made possible by the operating position “unlocked” being mechanically “stored” in the manner described below. After releasing the outside actuating element (outside door handle) again, with repeated pulling, door opening is made possible. Also in this respect, there can be an overload safeguard 35 in the lock mechanism 9 having a reverse direction of action.

In the overload safeguards known from the prior art, there is always an additional component, especially an additional lever, which is provided with a catch or which is pretensioned with a spring. In accordance with the present invention, the overload safeguard 35 can be made integrally in one of the coupled levers, especially in the form of the inherent elasticity of the lever overall, or in a certain range. In such an embodiment, one of the participating levers acts, to a certain extent, as an overload safeguard 35, without the need for separate components to implement the overload safeguard 35. This requires certain material-engineering constraints for the affected levers which can be implemented with current modem materials and production methods.

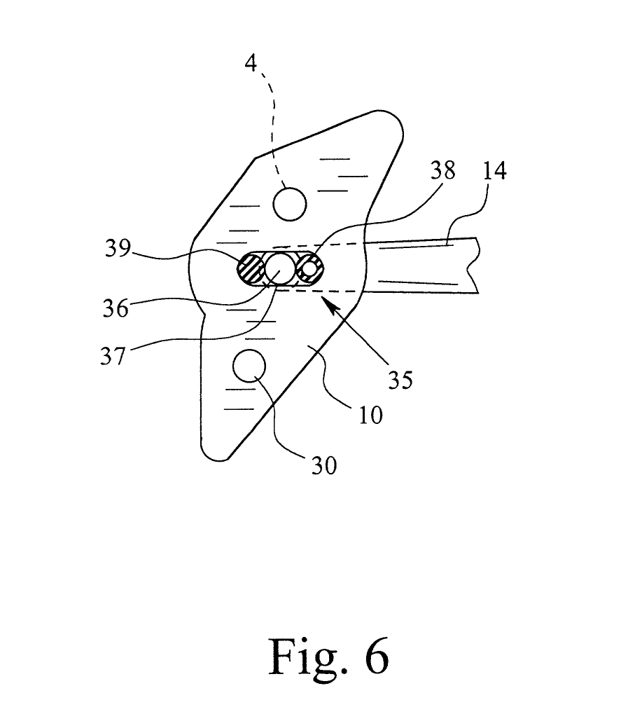

The preferred embodiment of an overload safeguard 35 is schematically shown in FIG. 6 which has an especially simple structure that is novel. This overload safeguard 35 is made as an elongated hole/journal connection with a spring element 38 which is located between the journal 36 and the elongated hole 37 in the direction of the relative motion of the two levers 10 and 14. As can be seen, FIG. 6 only shows the area in which the central safety lever 14 is connected to the inside safety lever 10.

In this embodiment, it is provided that the overload safeguard 35 acts identically in a two-fold manner, specifically by the journal 36 in the elongated hole 37 being clamped between two spring elements 38 and 39, the spring elements 38 and 39 having different spring coefficients (i.e. hardnesses). In this way, by using the spring element 38 with lower spring hardness, a type of “storage effect” is accomplished in one direction which can be used, for example, for the “enhanced circuit” described above. In the other direction however, the spring element 39 which has higher spring hardness, only prevents overload and provides for resetting, and for example, can be used for the “lockout safety”.

The preferred embodiment shown otherwise illustrates each spring element 38 and 39 as an elastomer element which may be a rubber spring of a certain hardness. This is one preferred embodiment but this does not preclude the fact that other types of spring elements, especially steel springs, can be alternatively used here.

These and other figures show various other features which also provide important features for the motor vehicle door lock in accordance with the illustrated embodiment of the present invention.

FIGS. 3, 4, and 7 show that in the preferred embodiment, the cover plate 3 is bent to the outside by 90°, the bend 40 projecting into the area of the lock mechanism 9 or beyond, and at least one lever, here the inside actuation lever 12, being is supported on the bend 40.

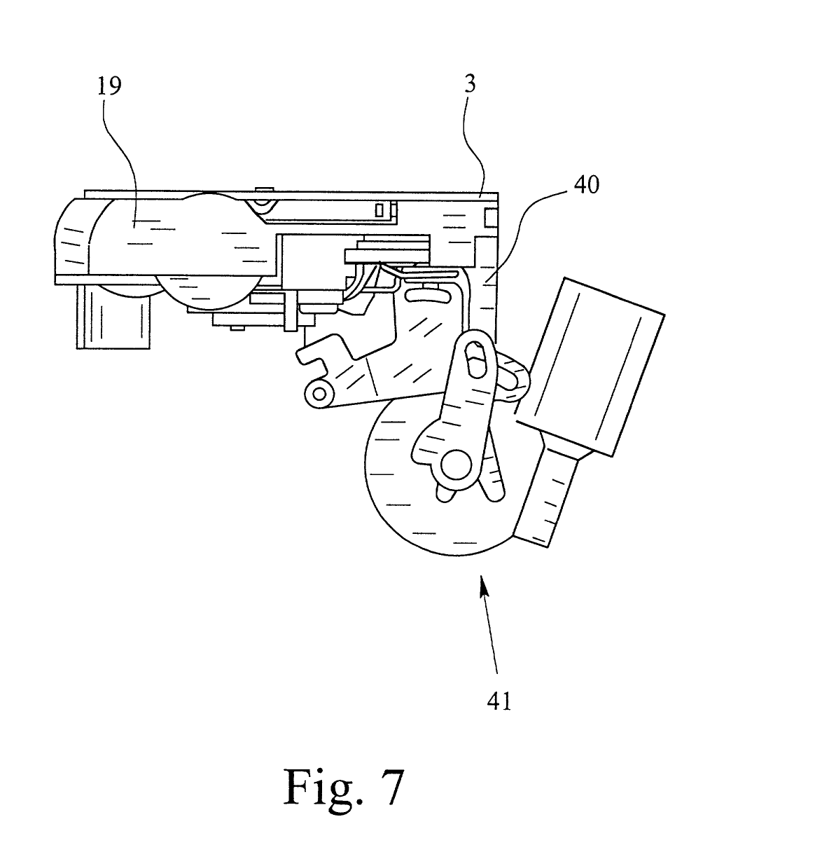

Furthermore, it can be recognized, especially in FIG. 7, that other additional modules such as an open by wire (OBW) module 41 may be attached to the bend 40. One such construction makes it possible to retrofit the motor vehicle door lock, if necessary, for special equipment versions of the affected motor vehicle.

The embodiment shown in FIGS. 1 to 4 shows a motor vehicle door lock with a mechanical child safety lever 16 on the bend 40, while FIG. 7 shows the function of a motorized child safety module which is integrated into the OBW module 41. This integration of a combined opening aid and child safety module into such a motor vehicle door lock which has an open by wire (OBW) function as provided by an OBW module is the subject matter of German application DE 199 63 910 A1 which is incorporated herein by reference, the German application DE 199 63 910 A1 being unpublished before the priority date of the present application.

While various embodiments in accordance with the present invention have been described, the present invention is not limited thereto. Various modifications, variations and additions will now become evident to persons skilled in the art. Therefore, the present invention is not limited to the details shown and described herein, but includes all such modifications, variations and additions.

We claim:

1. A motor vehicle door lock with a compact structure, comprising:
a housing having an inlet slot adapted to receive at least one of a lock hook and a catch bearing, and also having an intermediate wall with two sides;
a stiff cover plate that covers at least a portion of the housing;
at least two bearing axes having a lock element supported thereon, each bearing axes being supported by one side of the intermediate wall; and
a lock mechanism with plurality of levers which are at least one of pivotally and movably supported on the at least two bearing axes, the plurality of levers being mounted on another side of the intermediate wall of the housing;
wherein at least one of the lock elements are anchored to at least one of the cover plate and a bearing journal.

2. The motor vehicle door lock of claim 1, wherein at least one of the lock elements is anchored to a bearing journal molded to the housing.

3. The motor vehicle door lock of claim 1, wherein at least one of the lock elements is anchored to a bearing journal molded on the cover plate.

4. The motor vehicle door lock of claim 1, wherein the lock elements include a lock latch and a detent pawl.

5. The motor vehicle door lock of claim 2, wherein the bearing journal molded to the housing includes an asymmetrical, T-shaped head at one end, and a lever supported thereon includes an appropriate shaped opening that allows the lever to be slipped on and turned around the bearing journal by a certain angle of approximately 90° to thereby secure the lever against being pulled off of the bearing journal.

6. The motor vehicle door lock of claim 1, wherein the housing includes an integrated section for holding a central interlock drive, the integrated section being adapted to be covered with a plastic cover.

7. The motor vehicle door lock of claim 6, wherein the central interlock drive includes an electric drive motor, a threaded spindle coupled to a centrifugal clutch and parallel to the electric drive motor, a running nut, and a swiveling operating lever adapted to be moved by the running nut, the operating lever extending from the integrated section for the central interlock drive into the lock mechanism.

8. The motor vehicle door lock of claim 4, wherein the bearing axis of the lock latch includes a bearing mount on an end facing the lock mechanism, the bearing mount being adapted to receive a bearing journal of the swiveling operating lever.

9. The motor vehicle door lock of claim 8, wherein the plastic cover of the central interlock drive includes another bearing mount adapted to receive another bearing journal of the operating lever.

10. The motor vehicle door lock of claim 1, wherein at least one of the plurality of levers has a clevis type eyelet and a guide hook which is at angle thereto for connecting an actuating element to the lever.

11. The motor vehicle door lock of claim 1, wherein at least one of the plurality of levers is coupled to a flat spiral spring and is spring-pretensioned, the flat spiral spring being locked by a beveled clip on the cover plate, the clip having an undercut on an edge-side.

12. The motor vehicle door lock of claim 1, wherein at least one of the plurality of levers of the lock mechanism is coupled to another lever via an overload safeguard.

13. The motor vehicle door lock of claim 12, wherein the at least one of the plurality of levers is an inside safety lever and the another lever is a central safety lever.

14. The motor vehicle door lock of claim 13, wherein the overload safeguard is integrally provided in one of the coupled levers by the lever's elasticity.

15. The motor vehicle door lock of claim 12, wherein the overload safeguard includes a journal received in an elongated hole with at least one spring element located between the journal and the elongated hole.

16. The motor vehicle door lock of claim 15, wherein the journal is received in the elongated hole between two spring elements.

17. The motor vehicle door lock of claim 16, wherein the two spring elements have different spring hardnesses.

18. The motor vehicle door lock of claim 15, wherein the at least one spring element is an elastomer element.

19. The motor vehicle door lock of claim 1, wherein the cover plate includes a bend at about 90° that projects into the lock mechanism.

20. The motor vehicle door lock of claim 19, further including at least one of a lever, an open by wire (OBW) module, and a child safety module supported on the bend.
